(19) United States
(12) Patent Application Publication
(10) Pub. No.: US 2020/0079603 A1
(43) Pub. Date: Mar. 12, 2020

(54) DOCK LEVELER WITH INTEGRATED LIGHTS

(71) Applicant: Grant Leum, Excelsior, MN (US)

(72) Inventor: Grant Leum, Excelsior, MN (US)

(21) Appl. No.: 16/125,185

(22) Filed: Sep. 7, 2018

(51) Int. Cl. B65G 69/00; B60P 1/04; F21S 4/26

(52) U.S. Cl. CPC B65G 69/005; F21S 4/26; B65G 69/006; B60P 1/045

(57) ABSTRACT

A truck leveler for use with a driveway includes a planar ramp member having opposed sidewalls, a lower end terminating in a lower edge and an upper end with an upper edge. The embodiment further includes the sidewalls having a light-mounting channel therealong with at least one light integrated into the light-mounting channel. The automated or manual light(s) act to help guide a vehicle when backing in or pulling away from the truck leveler.

### FIELD OF THE INVENTION

This invention relates to truck levelers and more particularly to a truck leveler having integrated lights for safety.

### BACKGROUND OF THE INVENTION

A variety of truck levelers have been devised to adjust the height of different trailers to properly match the deck of the trailer to the height of the dock. By aligning the height of the trailer and the dock the loading and unloading of cargo is facilitated.

One such device is seen in U.S. Pat. No. 4,624,446 to Gould which discloses a reinforced platform pivotally mounted to the ground at one end and includes a support assembly having hydraulic cylinders. In operation the rear wheels of a truck trailer are backed onto the platform and then the non-mounted end of the platform is lifted by the hydraulic cylinders until the deck of the trailer is equal to the height of the dock.

A similar device is disclosed in U.S. Pat. No. 4,765,792 to Cherry, et al. which also discloses a pivotally-mounted and hydraulically-raised platform. In addition to the disclosure of Gould, the device includes mounting the hydraulics inwardly from the non-mounted end of the platform and an aperture in the non-mounted end of the platform to accommodate a truck restraining device.

Another design is disclosed in U.S. Pat. No. 6,368,043 to Leum, et al. which teaches a low-profile truck leveler. In this design a low-profile leveler is enabled through the use of a raised rear beam and two lateral beams that extend above the upper surface of the platform. In addition, a central beam adds further to the leveler's strength and rigidity.

Some truck levelers of the prior art include surface lights, however, none of these levelers include an integrated light system built into the leveler for added safety. It is to this need that this invention is drawn.

This device overcomes certain problems and shortcomings in the prior art, including those mentioned above and others, and provides advantages for a truck leveler not previously provided.

### SUMMARY OF THE INVENTION

A first embodiment of the present invention includes a truck leveler comprising a planar ramp member having opposed sidewalls, a lower end terminating in a lower edge and an upper end including an upper edge, the sidewalls having a light-mounting channel therealong with at least one light integrated into the light-mounting channel, whereby the light(s) assist vehicles when they are backing in or pulling away from the truck leveler.

It is highly preferred that the truck leveler include a support bracket attached to the light-mounting channel to direct the light toward a centerline of the planar ramp member. Preferably, the light is directed under the vehicle on the truck leveler for maximum visibility.

It is also preferred that the at least one light is an LED rope light and that the at least one light is red, white, blue or green in color. Preferred embodiments include that the lights either manually or automatically change from green to red when the vehicle is restrained on the planar ramp member of the truck leveler as well as that the lights either manually or automatically change from red to green when the vehicle is safe to leave the planar ramp member of the truck leveler.

A second embodiment of the present invention preferably includes a truck leveler comprising a wheel riser with a planar ramp member having a ramp portion including a wheel-contact grate portion and an open portion, both portions are along the entire length of the planar ramp member. The planar ramp member also preferably includes opposed sidewalls, a lower end terminating in a lower edge and an upper end including an upper edge, the sidewalls having a light-mounting channel therealong with at least one light integrated into the light-mounting channel, whereby the light(s) assist vehicles when they are backing in or pulling away from the truck leveler.

A third embodiment of the present invention preferably includes a free-standing wheel guide secured to the ground comprising opposed elongate side portions, each side portion having a light-mounting channel therealong with at least one light integrated into the light-mounting channel, whereby the light(s) assist vehicles when they are backing in or pulling away from a dock.

### BRIEF DESCRIPTION OF THE DRAWINGS

The drawings illustrate preferred embodiments including the above-noted characteristics and features of the device. The device will be readily understood from the descriptions and drawings. In the drawings:

FIG. 1 is a top view of the truck leveler of the first embodiment;

FIG. 2 is a front view of the truck leveler of FIG. 1;

FIG. 3 is a cutaway view taken along line 3-3 of FIG. 2 showing the light channel of the truck leveler of FIG. 1;

FIG. 4 is a side view of the truck leveler of FIG. 1;

FIG. 5 is a cross-sectional view taken along line 5-5 of FIG. 4 illustrating the light channel and light;

FIG. 6 is a side view of the truck leveler of the second embodiment;

FIG. 7 is a top view of the truck leveler of FIG. 6;

FIG. 8 is a perspective view of the truck leveler of FIG. 6 with a trailer on the truck leveler;

FIG. 9 is a perspective view of one side the ramp portion of the truck leveler of FIG. 6;

FIG. 10 is an end view of one side of the ramp portion of the truck leveler of FIG. 6;

FIG. 11 is a cross-sectional view taken along line 11-11 of FIG. 10 illustrating the light channel and light;

FIG. 12 is a perspective view illustrating the light channel and light of the truck leveler of FIG. 6;

FIG. 13 is a cross-sectional view taken along line 13-13 of FIG. 12 illustrating the light channel and light;

FIG. 14 is a top view of the wheel guides of the third embodiment;

FIG. 15 is an end view of the wheel guides of FIG. 14;

FIG. 16 is a perspective view of one of the wheel guides of FIG. 14;

FIG. 17 is an end view of one of the wheel guides of FIG. 14;

FIG. 18 is a cross-sectional view taken along line 18-18 of FIG. 17 illustrating the light channel and light;

FIG. 19 is a perspective view illustrating the light channel and light of the truck leveler of FIG. 14; and

FIG. 20 is a cross-sectional view taken along line 20-20 of FIG. 19 illustrating the light channel and light.

### DETAILED DESCRIPTION OF PREFERRED EMBODIMENTS

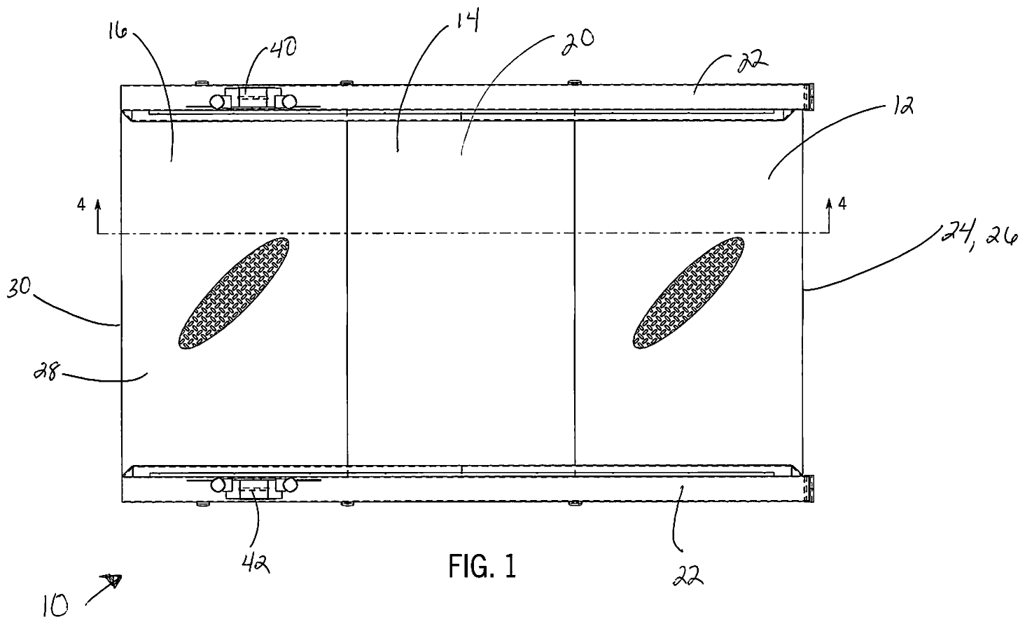

There are three embodiments in the present invention. The first, preferred embodiment of the present invention is shown in FIGS. 1-5. The truck leveler 10, as shown in FIG. 1, includes three primary portions: a first portion 12, second portion 14 and a third portion 16 and is designed to be utilized in conjunction with a substantially flat driveway near a loading dock wall 18. Furthermore, the leveler 10 can be moved between a lowered position and a raised position.

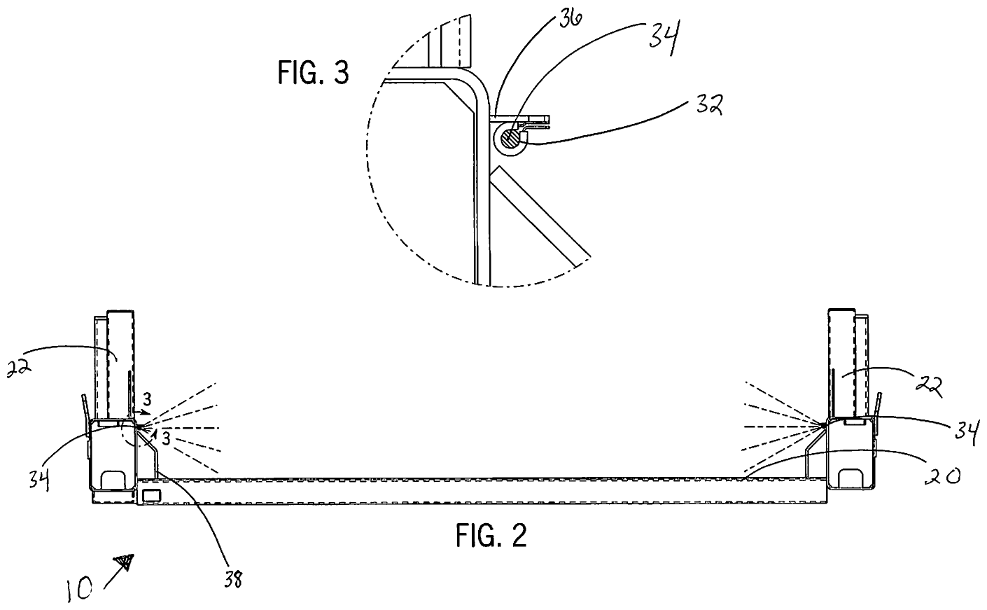

FIG. 1 illustrates that the first portion 12, second portion 14 and third portion 16 comprise a planar ramp member 20. Planar ramp member 20 as seen in FIGS. 1-2 includes opposed sidewalls 22, a lower end 24 terminating in a lower edge 26 and an upper end 28 including an upper edge 30. Planar ramp 20 member can be comprised of many suitable material including, but not limited to, a solid diamond plate metal material or an open-grate material.

As seen best in FIGS. 3-5, sidewalls 22 have a light-mounting channel 32 along the length of the sidewalls with at least one light 34 integrated into light-mounting channel 32. Light(s) 34 assist vehicles, such as trailers, when they are backing in or pulling away from truck leveler 10.

FIG. 3 illustrates best that truck leveler 10 has a support bracket 36 attached to the light-mounting channel 32 to direct light 34 toward a centerline 38 of planar ramp member 20. One purpose for support bracket 36 is to direct the light 34 partially under the vehicle on the truck leveler 10 so as to assist the vehicle operator when manuevering the vehicle. The preferred angle for the light(s) is 45 degrees but various angles can be used, any of which would optimize the amount of light shining onto the planar ramp member. The angle of light(s) can also be adjustable so as to optimize the amount of light which shines onto the planar ramp member 20 in various lighting and weather-related conditions and to vary it accordingly to such conditions.

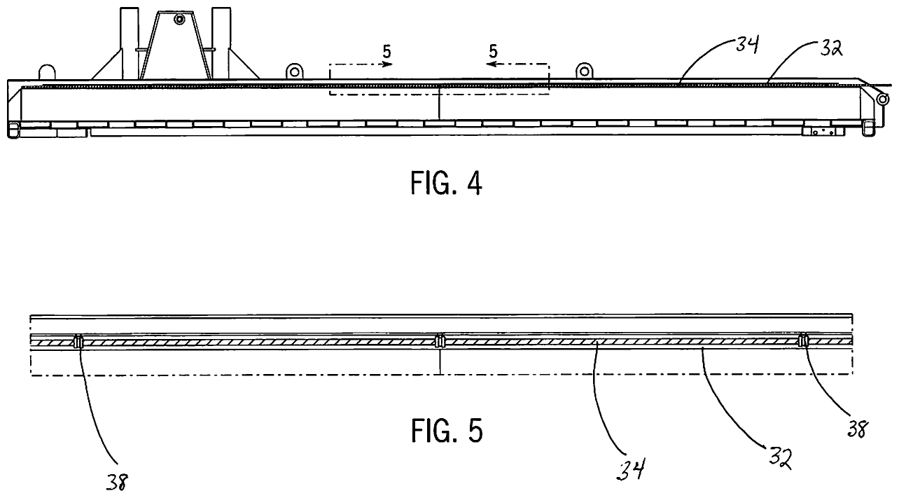

Light(s) 34 can be an LED, several LEDs or even an LED rope light as seen in FIGS. 4-5. FIGS. 4-5 illustrate that there are securing structures 38 at various locations along the length of light-mounting channel 32 which assist in securing the light(s) 34 within light-mounting channel 32.

An advantage and feature of light(s) 34 is that they are mounted to a plate to minimize light broadcast to an adjacent mounted guide or lift. This is also done to avoid possible mis-communication from dock to dock (when there are multiple docks) when the lights are interconnected to a dock safety system so that the light(s) 34 flash red and green to indicate when a truck can safely pull in or out of the dock.

Light(s) 34 can also be interconnected to a vehicle restraint that locks the truck at the dock. The vehicle restraint is interconnected and communicates with the light(s) 34. The guide lighting works in parallel with the vehicle restraint outside light communication system and is wired to match the same.

The light(s) 34 generally include at least one light being red, one white and one blue or green in color. Light(s) 34 can either manually or automatically change from green to red when the vehicle is restrained on planar ramp member 20 of truck leveler 10. Light(s) 34 also can either manually or automatically change from red to green when the vehicle is safe to leave planar ramp member 20 of truck leveler 10.

The white light is primarily used for truck leveler 10 during daylight hours since it is the brightest lighting for a vehicle operator to see when backing into a building (which is typically darker than daylight) or dock. Oftentimes it can be difficult for a driver to see due to bright sunlight outside the building. In embodiments which incorporate a single rope light it should be noted that the colors of the light can be changed based on how the light is powered. Multiple LEDs and rope lights (of the same or varying colors) located in the same light-mounting channel 32 are also within the scope of the invention.

Additionally, embodiments of the invention include a three position switch for the light(s) 34. The positions of the switch include “Load,” “Do Not Load,” and “Off.” It is advantageous to include an “Off” position for use during non-business hours at most locations at which the truck leveler would be utilized.

Pivot supports 40, 42 are included in the first embodiment of truck leveler 10 and can be incorporated into any leveler in which one end is pivotally attached to or resting on the ground and the opposite end is lifted from the ground, thus raising a truck parked on the leveler. In the current embodiment, the pivot supports 40, 42 comprise a base plate and a raised section (not shown).

A lifting system is also incorporated into the leveler 10 of the first embodiment in the form of hydraulic lifts (not shown). The hydraulic lifts assist in lifting a section of the leveler 10. However, any other lifting systems known in the art could be utilized as well.

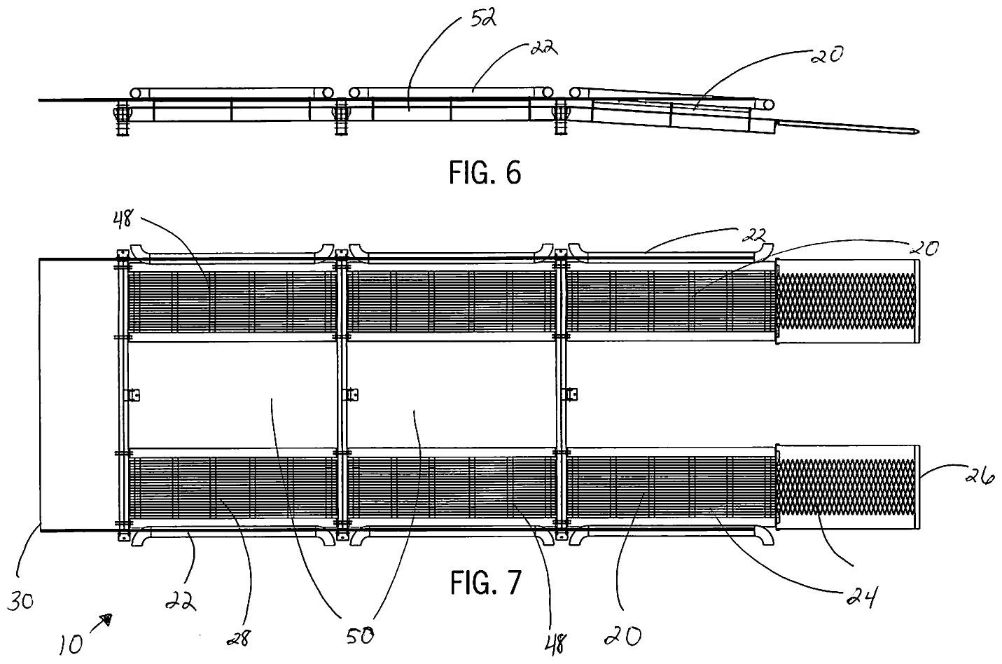

A second embodiment of the present invention is seen in FIGS. 6-13. The second, preferred embodiment includes planar ramp member having an open section in the middle of the planar ramp member as seen best in FIG. 7.

FIGS. 6-13 illustrate a truck leveler 10 being a wheel riser 44 with a planar ramp member 20 having a ramp portion 48 including a wheel-contact grate portion 48 and an open portion 50, both being along the length of planar ramp member 20.

FIG. 7 illustrates that truck leveler 10 of the second embodiment includes opposed sectional sidewalls 22, lower end 24 terminating in lower edge 26, middle ramp section 52 and upper end 28 including an upper edge 30. Ramp portion 48 can be made of an open-grate material or a solid diamond plate material as seen in FIG. 7. Preferably, lower end 24 is made of a solid diamond plate material and is also at an incline upwards toward middle ramp section 52 and upper end 28. Upper end 28 as well as middle ramp section 52 can be made of an open-grate material so as to allow rain or snow to fall through the ramp member.

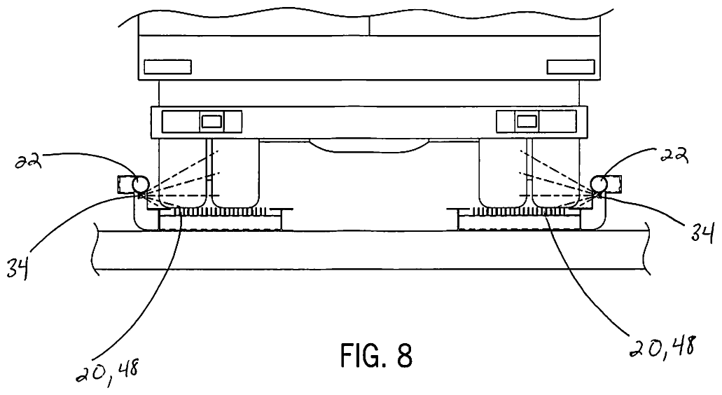

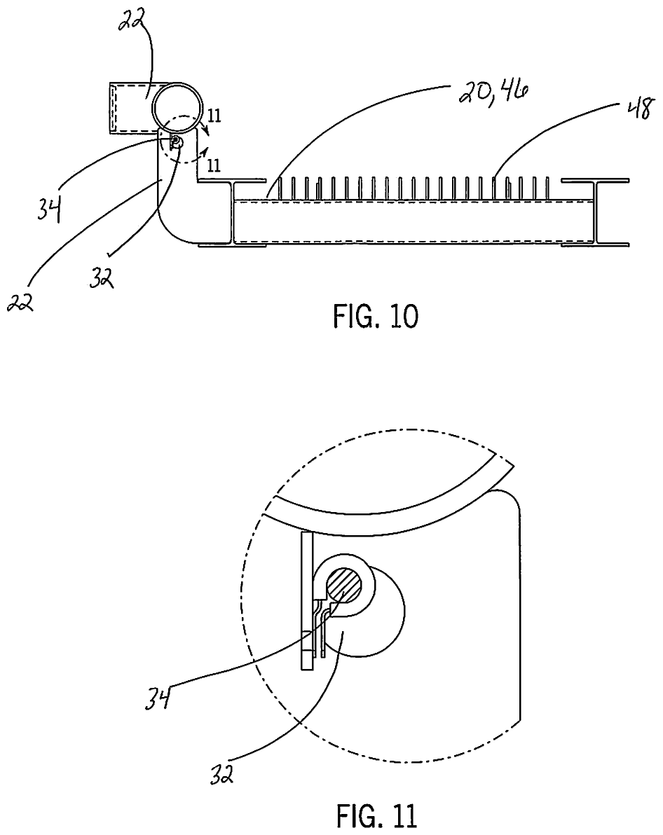

Sidewalls 22 have a light-mounting channel 32 therealong with at least one light 34 integrated into light-mounting channel 32 as seen best in FIGS. 10-13. FIG. 8 illustrates how the light shines from light(s) 34 in light-mounting channel 32 onto planar ramp member 20 to assist vehicles, such as trailers, when they are backing in or pulling away from the truck leveler.

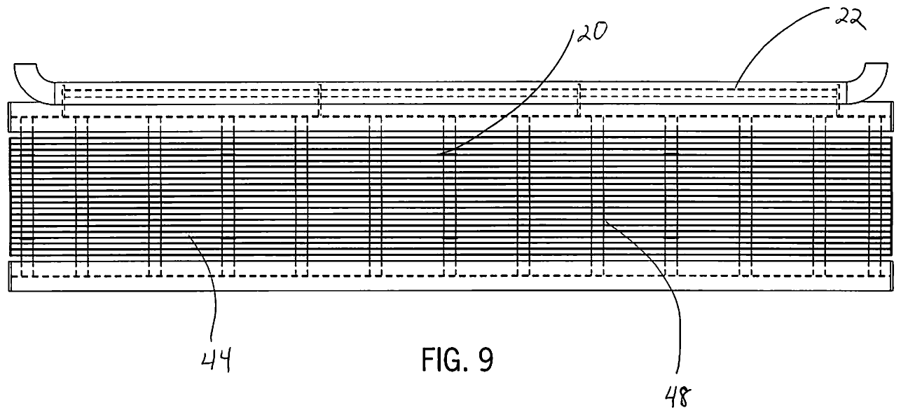

FIG. 9 illustrates half of one section of planar ramp member 20 showing in detail the open grate structure as well as one of the sectional sidewalls 22. Many sectional sidewalls 22 may make up the full length of planar ramp member 20 and light(s) 34 also extend along the full length of planar ramp member 20 and are continuous along the sectional sidewalls 22.

FIGS. 10-11 show in detail the location of light-mounting channel 32 as well as light(s) 34 within light-mounting channel 32.

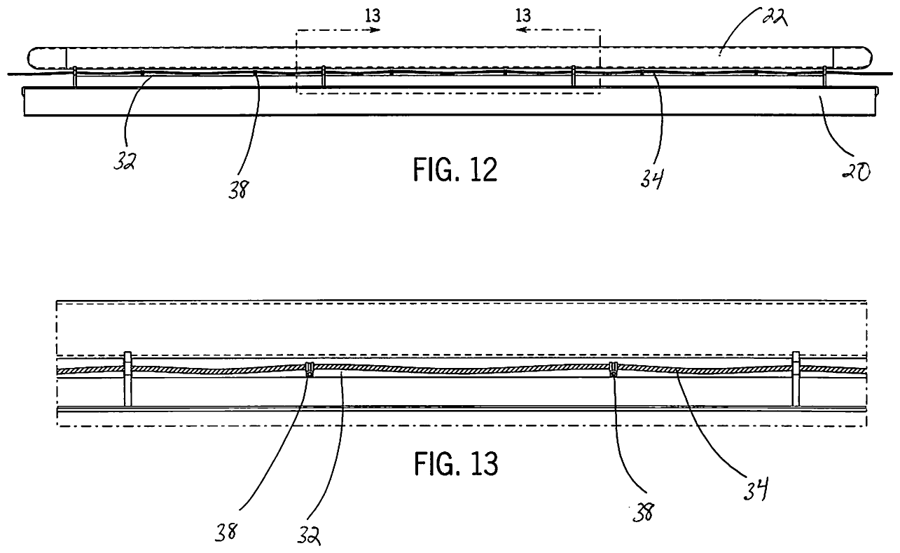

Similar to the first embodiment and as seen in FIGS. 12-13, light(s) 34 can be an LED, many LEDs or even an LED rope light. FIGS. 12-13 illustrate that there are securing structures 38 at various locations along the length of light-mounting channel 32 which assist in securing light(s) 34 in the channel 32.

The above discussion regarding the preferred types of light as well as its respective location is also applicable to this embodiment and is incorporated herein.

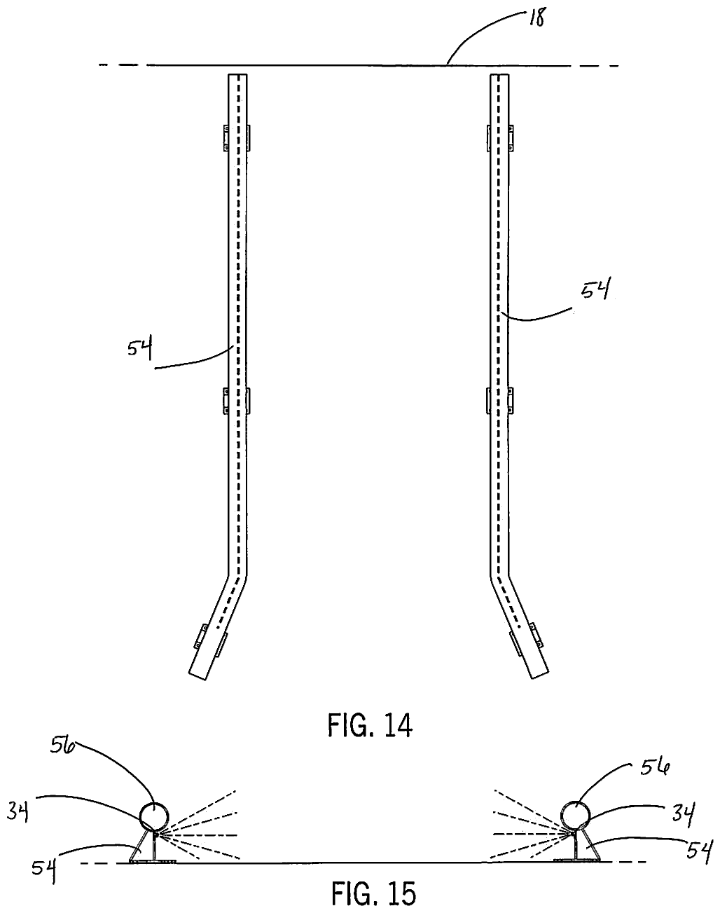

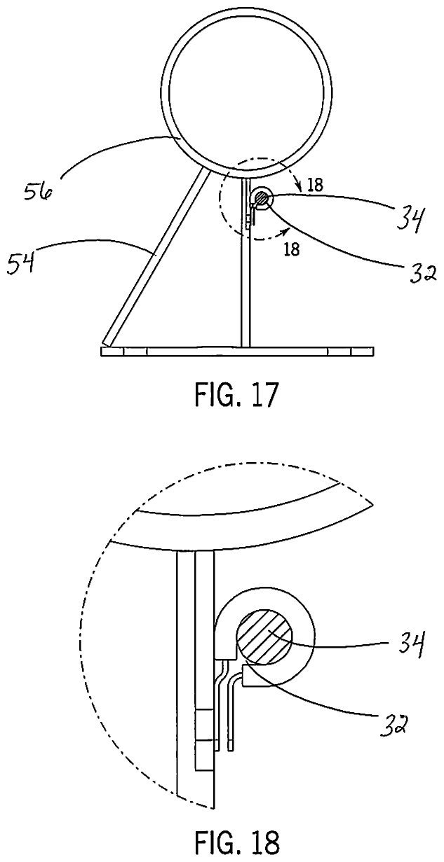

A third embodiment of the present invention is seen in FIGS. 14-20. The third, preferred embodiment includes opposing, free-standing wheel guides 54 secured to the ground. Wheel guides 54 act to guide the wheels of the trailer into position. Wheel guides 54 include opposed elongate side portions 56, each side portion 56 has a light-mounting channel 32 therealong with at least one light 34 integrated into the light-mounting channel 32. As in the other related embodiments, light(s) 34 assists vehicles when they are backing in or pulling away from a dock.

The above discussion regarding the preferred types of light as well as its respective location is also applicable to this embodiment and is incorporated herein.

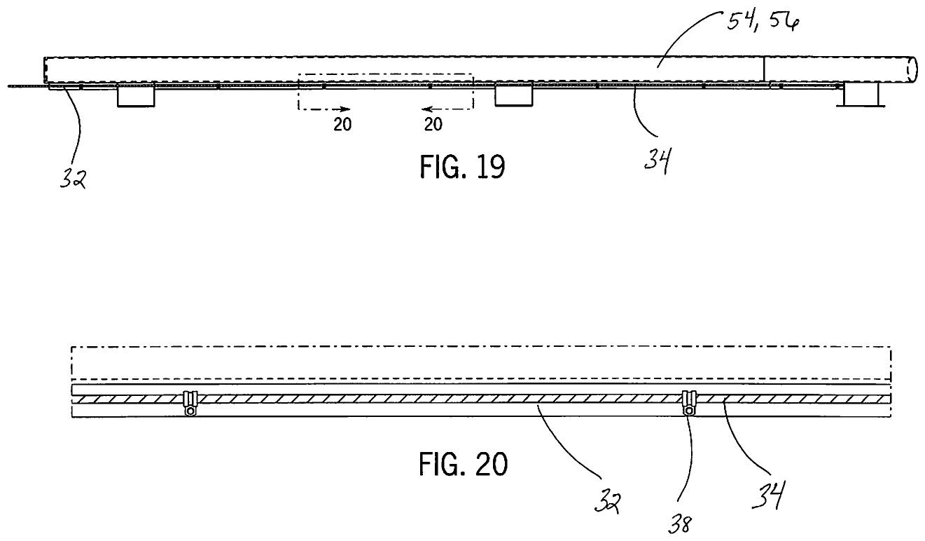

FIGS. 15 and 17-18 illustrate the location of light(s) 34 and light-mounting channel 32. FIGS. 19-20 illustrate that there are securing structures 38 at various locations along the length of light-mounting channel 32 which assist in securing the light(s) 34 within channel 32 as in the other embodiments.

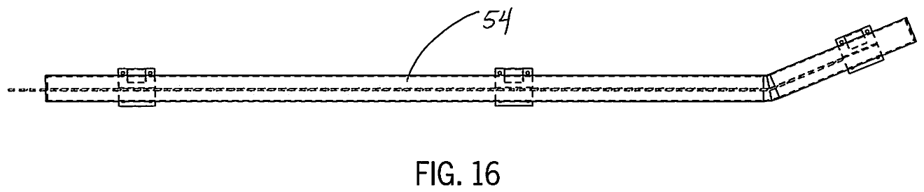

FIGS. 14 and 16 illustrate the overall shape of wheel guides 54 as well as that they are intermittently bolted to the grade (adjacent to a dock door) to secure them in place.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A truck leveler comprising a planar ramp member having (a) opposed sidewalls, (b) a lower end terminating in a lower edge and (c) an upper end including an upper edge, the sidewalls having a light-mounting channel therealong with at least one light integrated into the light-mounting channel, a support bracket attached to the light-mounting channel to direct the light toward a centerline of the planar ramp member, wherein the light(s) assist vehicles when they are backing in or pulling away from the truck leveler.

2. (canceled)

3. The truck leveler of claim 1 wherein the light is directed under the vehicle on the truck leveler.

4. The truck leveler of claim 1 wherein the at least one light is an LED rope light.

5. The truck leveler of claim 1 wherein the at least one light is red, white, blue or green in color.

6. The truck leveler of claim 5 wherein the at least one light is either manually or automatically changed from green to red when the vehicle is restrained on the planar ramp member of the truck leveler.

7. The truck leveler of claim 5 wherein the at least one light is either manually or automatically changed from red to green when the vehicle is safe to leave the planar ramp member of the truck leveler.

8. A truck leveler comprising a wheel riser with a planar ramp member having (a) a ramp portion including a wheel-contact grate portion and an open portion, both portions along the length of the planar ramp member, (b) opposed sidewalls, (c) a lower end terminating in a lower edge and (d) an upper end including an upper edge, the sidewalls having a light-mounting channel therealong with at least one light integrated into the light-mounting channel, a support bracket attached to the light-mounting channel to direct the light toward a centerline of the planar ramp member, wherein the light(s) assist vehicles when they are backing in or pulling away from the truck leveler.

9. (canceled)

10. The truck leveler of claim 8 wherein the light is directed under the vehicle on the truck leveler.

11. The truck leveler of claim 8 wherein the at least one light is an LED rope light.

12. The truck leveler of claim 8 wherein the at least one light is red, white, blue or green in color.

13. The truck leveler of claim 12 wherein the at least one light is either manually or automatically changed from green to red when the vehicle is restrained on the planar ramp member of the truck leveler.

14. The truck leveler of claim 12 wherein the at least one light is either manually or automatically changed from red to green when the vehicle is safe to leave the planar ramp member of the truck leveler.

15. A free-standing wheel guide secured to the ground comprising opposed elongate side portions, each side portion having a light-mounting channel therealong with at least one light integrated into the light-mounting channel, a support bracket attached to the light-mounting channel to direct the light toward a centerline of a planar ramp member, wherein the light(s) assist vehicles when they are backing in or pulling away from a dock.

16. (canceled)

17. The truck leveler of claim 15 wherein the light is directed under the vehicle.

18. The truck leveler of claim 15 wherein the at least one light is an LED rope light.

19. The truck leveler of claim 15 wherein the at least one light is red, white, blue or green in color.

20. The truck leveler of claim 19 wherein the at least one light is either manually or automatically changed from green to red when the vehicle is parked.

21. The truck leveler of claim 19 wherein the at least one light is either manually or automatically changed from red to green when the vehicle is safe to leave the planar ramp member of the truck leveler.
